(19) United States
(12) Patent Application Publication
(10) Pub. No.: US 2007/0046007 A1
(43) Pub. Date: Mar. 1, 2007

(54) Airbag assembly

(75) Inventor: Javier Zarazua, Rochester Hills, MI (US)

Correspondence Address: FOLEY AND LARDNER LLP;SUITE 500, 3000 K STREET NW, WASHINGTON, DC, 20007, US

(73) Assignee: TAKATA RESTRAINT SYSTEMS, INC.

(21) Appl. No.: 11/211,598

(22) Filed: Aug. 26, 2005

(51) Int. Cl. B60R 21/16

(52) U.S. Cl. 280/743.1

(57) ABSTRACT

An airbag assembly includes an airbag and a strap wrapped around the airbag to retain the airbag in a folded configuration prior to deployment. The strap includes a plurality of apertures for securing the strap to a support structure and a plurality of weakened areas at which the strip will break during deployment of the airbag.

### BACKGROUND

The present invention relates generally to the field of airbags and airbag assemblies for use in vehicles.

Inflatable airbags have become standard equipment in modern automobiles. Such airbags typically include a bag portion that inflates when a predetermined condition is met (e.g., an automobile impact). Airbag assemblies utilizing inflatable airbags may be positioned at various locations in a passenger compartment of an automobile (e.g., in a steering wheel or dashboard, etc.).

It is generally desirable to keep the airbag in a folded configuration prior to deployment. In cases where the airbag is not restrained by surrounding structures (e.g., an airbag cover for a steering wheel), a supplemental device or mechanism may be used to maintain the airbag in a folded configuration. For example, one conventional system utilizes a bag or sack for this purpose. In this system, a piece of material is preformed into a bag or sack into which the folded airbag may be provided. Upon deployment of the airbag, the sack may rupture to allow expansion of the airbag.

One difficulty with such a conventional system is that it requires additional manufacturing time and expense (e.g., cutting and sewing the sack, inserting the airbag into the sack, etc.). Another difficulty is that each sack may only be used with a limited number of airbags due to size and configuration constraints.

It would be desirable to provide an improved airbag assembly that includes a mechanism for keeping the airbag in a folded configuration prior to deployment. It would also be desirable to provide an improved airbag assembly that utilizes a mechanism for keeping the airbag in a folded configuration that is relatively simple and efficient to assemble and that reduces manufacturing costs.

### SUMMARY

An exemplary embodiment of the invention relates to an airbag assembly that includes an airbag and a strap wrapped around the airbag to retain the airbag in a folded configuration prior to deployment. The strap includes a plurality of apertures for securing the strap to a support structure and a plurality of weakened areas at which the strip will break during deployment of the airbag.

Another exemplary embodiment of the invention relates to an airbag assembly that includes a band spirally around an airbag and a support structure. The band includes a plurality of apertures for securing the band to the support structure and a plurality of perforations configured to break during inflation of the airbag

Another exemplary embodiment of the invention relates to a method that includes coupling an airbag to a support member. The method also includes wrapping a strip of material around the airbag and the support member. The strip includes a plurality of weakened areas spaced along the length of the strip at which the strip separates during deployment of the airbag. The method further includes coupling the strip of material to the support member at a plurality of locations.

It is to be understood that both the foregoing general description and the following detailed description are exemplary and explanatory only and are not restrictive of the invention as claimed.

### BRIEF DESCRIPTION OF THE DRAWINGS

These and other features, aspects, and advantages of the present invention will become apparent from the following description, appended claims and the accompanying exemplary embodiments shown in the drawings, which are briefly described below.

FIG. 1 is a plan view of a strap or band for use in an airbag assembly according to an exemplary embodiment.

FIG. 2 is a side plan view of a portion of an airbag assembly using a strap or band as shown in FIG. 1 according to an exemplary embodiment.

FIG. 3 is a side plan view of the airbag assembly shown in FIG. 2 illustrating the deployment of an airbag.

### DETAILED DESCRIPTION OF EXEMPLARY EMBODIMENTS

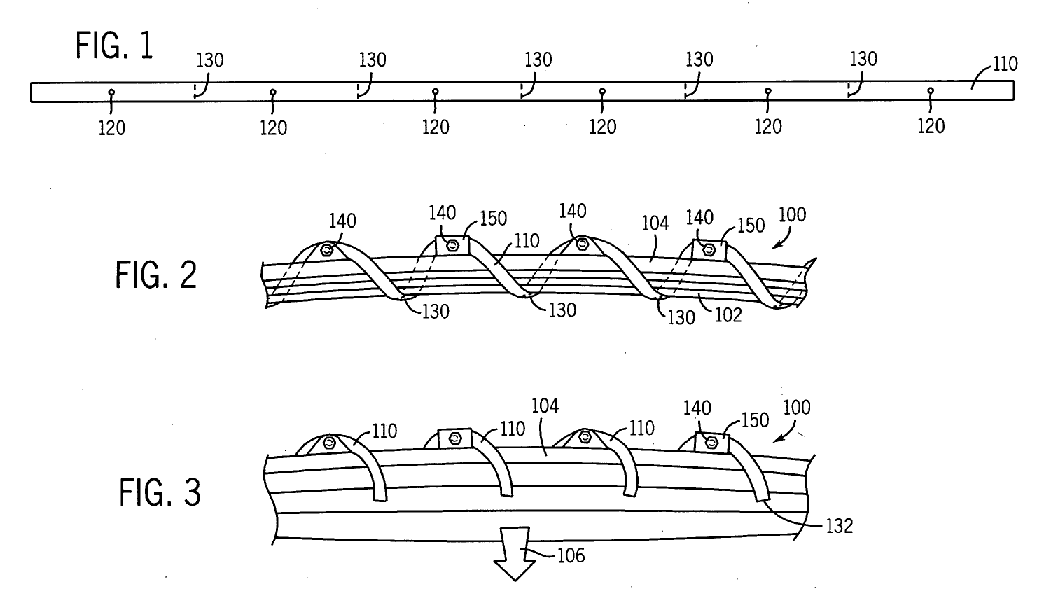

Referring to FIGS. 1-3, an airbag assembly 100 includes an airbag 102 coupled to a support member or structure 104 that may be installed at a location within a vehicle. The support structure 104 is made from a relatively rigid material to provide a structure to which the airbag 102 may be relatively securely attached. According to an exemplary embodiment, the support structure 104 is made of a metal or a relatively rigid polymeric material. According to other exemplary embodiments, the support structure 104 may be made of any other suitable material.

As shown in FIG. 2, a strap or band 110 is wrapped or wound around the support structure 104 and the airbag 102 (e.g., in a spiral configuration). According to an exemplary embodiment, the strap 110 is provided as a strip of material that is configured to retain the folded airbag 102 in place prior to deployment and to break at selected locations during deployment to allow the airbag 102 to inflate or expand.

FIG. 1 illustrates a plan view of the strap 110 prior to winding or wrapping around an airbag such as the airbag 102. According to an exemplary embodiment, the strap 110 has a width of between approximately 0.25 and 3.0 inches. According to other exemplary embodiments, the size and configuration of the strap may differ, for example, in accordance with requirements of a particular application (e.g., a larger airbag may require a longer strap, the length may vary with the fold pattern, attachment points, and final dimensions after folding, etc.).

According to an exemplary embodiment, the strap 110 is made of a fabric material, paper, or a polymeric material. According to other exemplary embodiments, the strap 110 may be made of any other suitable material that meets customer and/or government requirements and regulations (e.g., for flammability and performance). The particular material chosen may depend on any of a wide variety of factors, including cost, performance, ease of manufacturing, and the like.

As shown in FIG. 1, the strip 110 includes a number of apertures or holes 120 which may be used to secure the strip 110 to the support structure 104. The size, shape, and configuration of the apertures may vary according to various exemplary embodiments. According to an exemplary embodiment, the apertures 120 have a generally circular shape. According to another exemplary embodiment, the apertures may be provided as slits or another shape.

As shown in FIG. 2, the strip 110 is secured to members or elements 150 coupled to or extending from the support structure 104 by fasteners 140 such as bolts, screws, buttons or snaps, hook-and-loop fasteners such as Velcro, or the like. According to an exemplary embodiment, the fasteners 140 are provided as bolts which extend through the members 150 and the apertures 120 provided in the strip 110 to secure the strip to the support structure 140.

The distance between the apertures is selected to allow for alignment of the apertures with apertures provided in the members 150. According to an exemplary embodiment, the distance between the apertures provided in the members 150 is between approximately 10 and 15 inches and the distance between the apertures provided in the strip 110 is between approximately 10 and 15 inches. According to other exemplary embodiments, the spacing between the apertures provided in the members and/or the spacing between the apertures provided in the strip may vary according to the particular application (e.g., if the distance between the members 150 and/or the size of the airbag are larger, the spacing between the apertures in the strip will also be larger to compensate for the increased distance).

As shown in FIG. 3, the strip 110 is configured to break or split at two or more locations along its length upon inflation of the airbag. According to an exemplary embodiment, the strip 110 is configured to break or split at more than one point along its length upon inflation of the airbag. As shown in FIG. 1, the strip 110 includes weakened areas (shown in the form of perforations 130) where the strip 110 will break or split that are provided between apertures 120 (e.g., at the midpoint between the apertures 120). While FIG. 1 illustrates the use of perforations, according to other exemplary embodiments, other ways of weakening the strip may be utilized. For example, the thickness and/or width of the strip may be smaller in the weakened areas as compared to surrounding areas of the strip.

According to an exemplary embodiment as shown in FIG. 2, the perforations 130 are spaced along the strip 110 such that they are provided at a point where the airbag 102 will expand (e.g., at the bottom of the airbag assembly 100 as shown in FIG. 2). As the airbag expands in a direction denoted by an arrow 106 in FIG. 3, the strip 110 breaks at locations 132 to allow expansion of the airbag.

The weakened areas of the strip 110 (provided, e.g., as perforations) may be configured to break or split at a predetermined point during the expansion of the airbag 102. For example, the strip 110 may be configured to break or split when the force applied by the airbag against the strip exceeds a predetermined amount and/or when the time from initial inflation reaches a predetermined point (e.g., a predetermined number of milliseconds into the inflation). The strength of the strip 110 at the weakened areas may vary depending upon the particular application. For example, the strip may provide little or no resistance against the expansion of the airbag such that it is intended only for use in restraining the airbag in its folded configuration prior to any deployment (i.e., the strip will break immediately upon expansion of the airbag). According to another exemplary embodiment, the strip may act to restrain the initial inflation of the airbag for a predetermined period to reduce the rate and/or force with which the airbag expands.

One advantageous feature of an airbag assembly (e.g., airbag assembly 100) using a strip such as the strip 110 is that the necessity of using a preformed bag may be eliminated. The strip may be wound or wrapped around the airbag during the folding operation, minimizing the time and expense of assembly. That is, after attachment of the airbag to the support structure and folding of the airbag to its desired size and shape, the strip may be wound or wrapped around the airbag and support structure and coupled or attached to the support structure (or to members or elements attached or coupled to the support structure). Another advantageous feature of using a strip such as the strip 1 10 is that the strip may be cut to the appropriate length for a given application.

It is important to note that the construction and arrangement of the airbag assembly and strip as shown in the various exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, the nature or number of discrete elements or positions may be altered or varied. Accordingly, all such modifications are intended to be included within the scope of the present invention as defined in the appended claims. The order or sequence of any process or method steps may be varied or re-sequenced according to alternative embodiments. Other substitutions, modifications, changes and omissions may be made in the design, operating conditions and arrangement of the preferred and other exemplary embodiments without departing from the scope of the present inventions as expressed in the appended claims.

What is claimed is:

1. An airbag assembly comprising:
an airbag; and
a strap wrapped around the airbag to retain the airbag in a folded configuration prior to deployment, the strap comprising a plurality of apertures for securing the strap to a support structure and a plurality of weakened areas at which the strip will break during deployment of the airbag.

2. The airbag assembly of claim 1, wherein the strap is configured to break at the plurality of weakened areas, the weakened areas alternating along the length of the strap with the plurality of apertures.

3. The airbag assembly of claim 1, wherein the strap is configured to break at the plurality of weakened areas when a predetermined is applied to the strip by the airbag.

4. The airbag assembly of claim 1, wherein the weakened areas comprise perforations.

5. The airbag assembly of claim 1, wherein the weakened areas comprise an area than has at least one of a lesser width and a lesser thickness as compared to surrounding regions in the strap.

6. The airbag assembly of claim 1, wherein the strap is wrapped around the airbag in a generally spiral configuration.

7. The airbag assembly of claim 1, wherein the strap comprises at least two weakened areas spaced apart along the length of the strap.

8. The airbag assembly of claim 7, wherein the strap comprises a material selected from the group consisting of a fabric, a polymeric material, and a paper material.

9. The airbag assembly of claim 1, wherein the strap and the airbag are coupled to a support structure.

10. The airbag assembly of claim 9, wherein the strap is coupled to the support structure with fasteners which extend through the apertures.

11. An airbag assembly comprising:
a band spirally wrapped around an airbag and a support structure, the band comprising a plurality of apertures for securing the band to the support structure and a plurality of perforations configured to break during inflation of the airbag.

12. The airbag assembly of claim 11, wherein the perforations and apertures alternate along the length of the band.

13. The airbag assembly of claim 12, wherein the band comprises a material selected from the group consisting of a fabric material, a paper material, and a polymeric material.

14. The airbag assembly of claim 11, wherein the band is configured to split at at least one of the perforations when a force is applied to the band by the airbag.

15. The airbag assembly of claim 11, wherein the band has a width of between approximately 0.25 and 3.0 inches

16. A method comprising:
coupling an airbag to a support member;
wrapping a strip of material around the airbag and the support member, the strip comprising a plurality of weakened areas spaced along the length of the strip at which the strip separates during deployment of the airbag; and
coupling the strip of material to the support member at a plurality of locations.

17. The method of claim 16, wherein the strip of material comprises a material selected from the group consisting of a polymeric material, a paper material, and a fabric material.

18. The method of claim 16, wherein the step of coupling the strip of material to the support member comprises using a plurality of fasteners.

19. The method of claim 18, wherein the fasteners are selected from the group consisting of bolts, screws, buttons, snaps, and hook-and-loop fasteners.

20. The method of claim 16, wherein the step of coupling the strip of material to the support member comprises coupling the strip of material to a member coupled to the support structure.
